(19) United States
(12) Patent Application Publication
(10) Pub. No.: US 2004/0083377 A1
(43) Pub. Date: Apr. 29, 2004

(54) System and method for digital storage media copy protection

(75) Inventors: Pingfan Peter Wu, Niskayuna, NY (US); Radislav Alexandrovich Potyrailo, Niskayuna, NY (US); James Edward Pickett, Schenectady, NY (US); Peter William Lorraine, Niskayuna, NY (US); Marc Brian Wisnudel, Clifton Park, NY (US)

Correspondence Address: SCULLY SCOTT MURPHY & PRESSER, PC, 400 GARDEN CITY PLAZA, GARDEN CITY, NY, 11530

(73) Assignee: General Electric Company, Niskayuna, NY

(21) Appl. No.: 10/280,934

(22) Filed: Oct. 25, 2002

(51) Int. Cl. G06F 12/14

(52) U.S. Cl. 713/193; 380/201

(57) ABSTRACT

A storage medium capable of being read by player, the storage medium comprising: digital content disposed along one or more tracks of the storage medium; and an authentication program disposed along the one or more tracks of the storage medium for authenticating the storage medium by determining whether the one or more vague bits exist at the one or more predetermined locations. There are also provided a method for authenticating a storage medium and a method for creating a storage medium having the one or more vague bits.

### BACKGROUND OF THE INVENTION

The present invention generally relates to optical storage media copy protection. More particularly, the present invention is directed to a system and method for utilizing vague bits for optical, magneto-optical and hybrid storage media copy protection.

Optical, magneto-optical and hybrid storage media, such as for example, compact disks (CDs) and digital video disks (DVDs), are inextricably intertwined with present day's requirement for inexpensive yet reliable media that may hold large quantities of digital content for distribution to the consuming public. As used herein, optical, magneto-optical and hybrid storage media, as well as other like formats, are all examples of digital storage media. The foregoing digital storage media are utilized to store a variety of digital content, including digital music, video, computer software and other data. There are myriad media players for reading the digital content from the foregoing digital storage media, including, CD players, DVD players, CD-ROM payers, as well as game consoles, such as the Microsoft Corporation's Xbox™ and Sony's Playstation 2™. As used herein, the foregoing are all considered media players. It is noted that this is a non-exhaustive listing of media players, and that other media players are available.

In particular, the optical storage media, such as CDs and DVDS, are produced by a thermoplastic process. Injection molding is an exemplary thermoplastic process used for producing the optical storage media. The digital content on the optical storage media is a series of data bits represented as pits and lands, which are converted by an optical media player into a binary data stream, represented by zeros and ones. In one method of producing the optical storage media, pre-mastering digital content is recorded optically onto a surface of a master that is made, for example, of glass or substrate coated with a photoresist. A stamper is produced from the master by depositing a metal (for example, nickel) layer onto the master using an electroforming process. The stamper is then used to thermomold transparent optical disks (which will become the optical storage media) in a replication process. Once thermoformed, the transparent optical disks are coated with a reflective metal (for example aluminum, gold, and the like) layer using a process known as metalizing. The optical disks, such as CDs, are then coated with a protective lacquer to protect the reflective metal surfaces. This represents the final optical storage media. The optical disks for other optical storage media, such as DVDs, are protected by a bonding adhesive in the center of a DVD sandwich. Using a screen-printing process and methods known in the art, non-recorded surfaces of the optical storage media can display graphics, art or other printed information as necessary.

Billions of dollars in revenue are lost annually due to pirating of digital content stored on the foregoing digital storage media. A myriad of technical solutions have been proposed and many implemented to protect the digital content from illegal copying or unauthorized reproduction. For example, Microsoft Corporation has used expensive edge-to-edge and inner-hub-ring holograms on optical storage media to write a signature of the storage media. Additionally, authentication systems have been proposed to introduce errors, ambiguous symbols and logos on the storage media, utilizing lands and pits to encode the storage media, which can be verified to authenticate the storage media. However, to date, there appears to be no viable technical solution that has not already been compromised by unscrupulous hackers.

Therefore there is a need in the art of a system and method for providing a system and method for optical, magneto-optical and hybrid digital storage media copy protection.

### BRIEF SUMMARY OF THE INVENTION

According to an embodiment of the present invention, there is provided a storage medium capable of being read by a player, the storage medium comprising: digital content disposed along one or more tracks of the storage medium; one or more vague bits disposed at one or more predetermined locations along the one or more tracks of the storage medium; and an authentication program disposed along the one or more tracks of the storage medium for authenticating the storage medium by determining whether the one or more vague bits exist at the one or more predetermined locations.

According to another embodiment of the present invention, there is provided a storage medium storing digital content capable of being read by a player, the storage medium comprising: an authentication program disposed along the one or more tracks of the storage medium for authenticating the storage medium by determining whether there exist one or more vague bits disposed at one or more predetermined locations along the one or more tracks of the storage medium.

According to yet another embodiment of the present invention, there is provided a storage medium storing digital content along one or more tracks capable of being read by a player, the storage medium comprising: one or more vague bits disposed along one or more predetermined locations along the one or more tracks of the storage medium, at least one of the one or more vague bits is produced by a modulating technique selected from a group consisting of: i) modulating distance between two pits; ii) modulating width of a pit; iii) modulating depth of a pit; and iv) modulating reflectivity of a metal layer.

According to a further embodiment of the present invention, there is provided a method for authenticating a storage medium storing digital content capable of being read by a player, the method comprising: reading a predetermined location on the storage medium a plurality of times; comparing results from the plurality of readings of the predetermined location to determine whether the results are substantially the same for each reading; and directing the player to stop reading the digital content stored on the storage medium if the results are substantially the same.

According to yet a further embodiment of the present invention, there is provided a method for authenticating a storage medium storing digital content capable of being read by a player, the method comprising: reading a string of bits at a predetermined location on the storage medium a plurality of times; comparing strings from the plurality of readings of the predetermined location to determine whether the bits in the string are substantially the same for each reading; and directing the player to stop reading the digital content stored on the storage medium if the bits in the strings are substantially the same.

According to still a further embodiment of the present invention, there is provided a method for producing a storage medium having authentication and capable of being read by a player, the method comprising: adding one or more vague bits to a format for the storage medium; adjusting redundant bits in the format so as to make the one or more vague bits non-correctable via error correction means associated with the player during reading of the storage medium; creating a mask utilizing the format; making a master utilizing the mask; and stamping the storage medium from the master.

According to another embodiment, there is provided a method for producing a storage medium having authentication and capable of being read by a player, the method comprising: creating a mask utilizing a format for the storage medium, the mask comprising grooves for locating one or more predetermined locations; making a master utilizing the mask; stamping the storage medium from the master, the storage medium comprising a metal layer; adding the one or more vague bits to the storage medium at the one or more predetermined locations by modulating reflectivity of the metal layer at the one or more predetermined locations; and adjusting redundant bits corresponding to the one or more predetermined locations to make the one or more vague bits non-correctable via error correction means associated with the player during reading of the storage medium.

According to yet another embodiment, there is provided a program storage device, tangibly embodying a program of instructions executable by a machine to perform a method for authenticating the program storage device storing digital content capable of being read by the machine, the method comprising: reading a predetermined location on the program storage device a plurality of times; comparing results from the plurality of readings of the predetermined location to determine whether the results are substantially the same for each reading; and directing the machine to stop reading the digital content stored on the program storage device if the results are substantially the same.

According to a further embodiment, there is provided a program storage device, tangibly embodying a program of instructions executable by a machine to perform a method for authenticating the program storage device storing digital content capable of being read by the machine, the method comprising: reading a string of bits at a predetermined location on the program storage device a plurality of times; comparing strings from the plurality of readings of the predetermined location to determine whether the bits in the string are substantially the same for each reading; and directing the machine to stop reading the digital content stored on the program storage device if the bits in the strings are substantially the same.

### BRIEF DESCRIPTION OF THE DRAWINGS

The features and advantages of the present invention will become apparent to one skilled in the art, in view of the following detailed description taken in combination with the attached drawings, in which:

FIG. 1 depicts an exemplary illustration of readings obtained by a conventional CD/DVD player from an optical storage medium in accordance with the present invention;

FIG. 2 depicts a combination of a pit and a land in accordance with the present invention;

FIG. 3 depicts one example of one or more vague bits on a track of a storage medium according to the present invention;

FIG. 4 depicts another example of one or more vague bits on a track of a storage medium according to the present invention;

FIG. 5 depicts yet another example of one or more vague bits on a track of a storage medium according to the present invention;

FIG. 6 depicts still another example of one or more vague bits on a track of a storage medium according to the present invention;

FIG. 7 depicts a further example of one or more vague bits on a track of a storage medium according to the present invention;

FIG. 8 depicts an exemplary storage medium according to the present invention;

FIG. 9 depicts an exemplary player that may be employed to execute an authentication program to authenticate a storage medium according to the present invention;

FIG. 10 depicts an exemplary flowchart of one example for authenticating a storage medium in accordance with the present invention;

FIG. 11 depicts an exemplary flowchart of another example for authenticating a storage medium in accordance with the present invention;

FIG. 12 depicts an exemplary flowchart of a first example for creating a storage medium comprising one or more vague bits according to the present invention; and

FIG. 13 depicts an exemplary flowchart of a second example for creating a storage medium comprising one or more vague bits according to the present invention.

FIG. 14 depicts an exemplary flowchart of a third example for creating a storage medium comprising one or more vague bits according to the present invention.

### DETAILED DESCRIPTION OF THE INVENTION

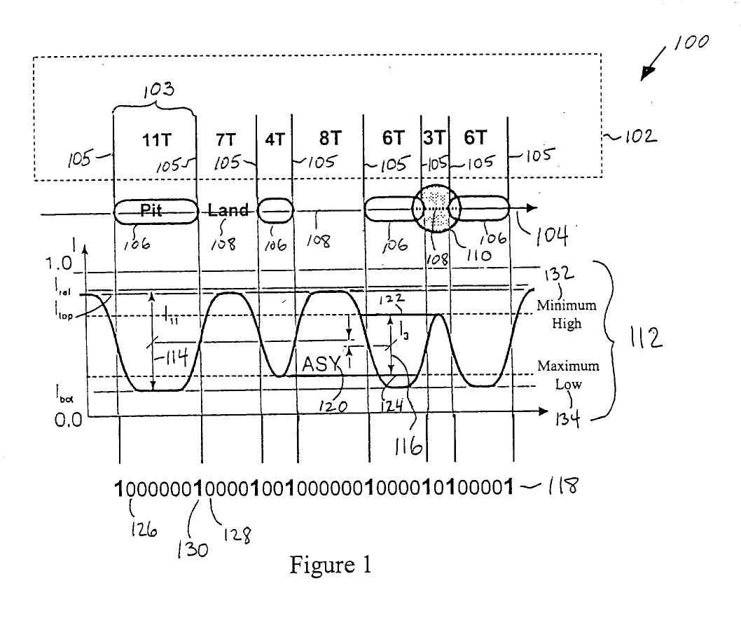

FIG. 1 is an exemplary illustration 100 that depicts readings obtained by a conventional media player (e.g., CD/DVD media player) from a digital storage medium (e.g., optical storage medium) in accordance with the present invention. Reference number 102 indicates a number of samples that the media player takes along a track 104 of the optical storage medium. For example, “11T” dictates that the media player takes eleven samples during section 103 along the track 104 of the optical storage medium. As particularly depicted in the exemplary illustration 100, other samples may be taken, such as for example, sample “3T”, which indicates that the media player takes three samples during that section of track 104. Although illustration 100 depicts one track 104 for conciseness and clarity, the storage medium comprises a plurality of tracks 104. Each track 104 comprises a plurality of pits 106 and lands 108. The land 108 is flat, reflecting a laser spot 110 produced by the media player like a mirror, so that it produces a maximum intensity reflection reading by a detector of the media player, while the pit has a depth, producing a minimum intensity reflection reading. Reference number 105 represents a transition from the pit 106 to the land 108 and vice versa.

Further with reference to FIG. 1, the media player moves the laser spot 110 produced by a laser (not shown) of the media player along track 104 to obtain intensity reflection readings as depicted in the intensity reflection reading waveform 112. I_{ref} is a peak value corresponding to a photodiode (not shown) output of the media player before high-pass filtering. Iₜₒₚ and I_{bot} represent, respectively, the maximum intensity reflection reading generated by a pure land 108(i.e., there is no destructive cancellation of the light) and the minimum intensity reflection reading generated by a pure pit 106 (i.e., there is destructive cancellation of the light). I₁₁ (also be called I₁₄) 114 represents a difference between the maximum intensity reflection reading (i.e., Iₜₒₚ) and the minimum intensity reflection reading (i.e., I_{bot}). I₃ 116 depicts a difference between the minimum intensity reflection high 132 and the maximum intensity reflection low 134 from the digital storage medium. More specifically, an upper level 122 of I₃ 116 represents the minimum intensity reflection high 132, while a lower level 124 of I₃ 116 is maximum intensity reflection low 134. In other words, I₃ 116 is a difference between minimum intensity reflection high 132 and maximum intensity reflection low 134. The conventional media player requires that I₃>0.15*I₁₁. ASY 120 depicts a signal asymmetry, which represents the difference between a center of I₁₁ 114 and center of I₃ 116. It is noted here that different media players have varied laser power, and the actual intensity reflection reading may not be the same as the Iₜₒₚ and I_{bot} illustrated in the intensity reflection reading waveform 112 across every media player. There is approximately a 10 percent variance in laser power across the different media players.

Yet further with reference to FIG. 1, the media player converts the intensity reflection reading waveform 112 into a binary data stream 118 (i.e., digital content). Taking samples along a pit 106, the media player produces a sequence of binary bits equal to zero 126 for the associated sampled section 103. Likewise, taking samples along land 108, the media player produces a sequence of binary bits equal to zero 128 for the associated sampled section. It is noted that the intensity reflection reading must at least be the minimum intensity reflection reading high 132 for the media player to produce a bit in binary data stream 118 that represents a part of a land 108 (i.e., bit equal to zero). Likewise, the intensity reflection reading must at most be the maximum intensity reflection reading low 134 for the media player to produce a bit in binary data stream 118 that represents a part of a pit 106 (i.e., bit equal to zero). When the intensity reflection reading transitions between a pit and land, as illustrated by the intensity reflection reading waveform 112 transition 105 between pit 106 and land 108, the media player converts the transition 105 to a binary bit equal to one 130 in the binary data stream 118.

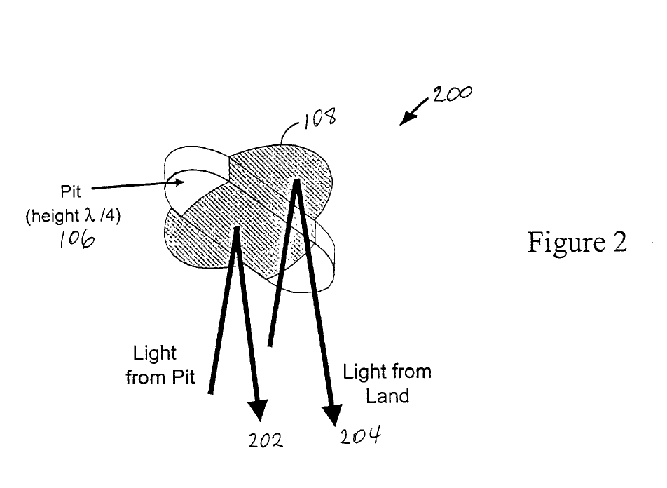

FIG. 2 is an exemplary illustration 200 that depicts pit 106 either above or below land 108 in accordance with the present invention. The pit 106 has a width narrower than the laser spot 110 depicted in FIG. 1 above. The height (or depth) of the pit 106 is approximately one-fourth of the wavelength in the digital storage media of the laser that produces the laser spot 110 in FIG. 1 above, which facilitates efficient data retrieval from the optical storage media. It is noted that the wavelength produced by the laser changes to λ/n when it enters the digital storage media, where λ represents the wavelength in a vacuum and n represents an index of refraction for the digital storage media. For example, for a given wavelength of 780 nm for the laser and an index of refraction of 1.58 for a polycarbonate digital storage medium, the depth of pit 106 is approximately 120 nm (i.e., 780/1.58/4=120). The light 202 reflected from the pit 106 destructively cancels the light 204 reflected from the land 108. Consequently, at a location shown in FIG. 2, the intensity reflection reading obtained by the detector from the laser spot 110 positioned over the location (i.e., sample) is determined by the media player to be a minimum intensity reflection reading. As aforementioned, because of the variation of laser power of media players, the detector intensity reflection reading of the taken sample may vary from the maximum intensity reflection reading Iₜₒₚ or the minimum intensity reflection reading I_{bot}. However, as noted above, the reading should be well above the minimum reflection intensity high 132 or well below the maximum intensity reflection high for the particular media player, so that the media player may determine either a maximum or a minimum intensity reflection reading. However, if the intensity reflection reading is in close proximity to the high 132 or to the low 134, it will either cause a jitter (distortion arising from timing errors) in the binary data stream or force the media player to randomly assume a maximum intensity reflection reading or a minimum intensity reflection reading.

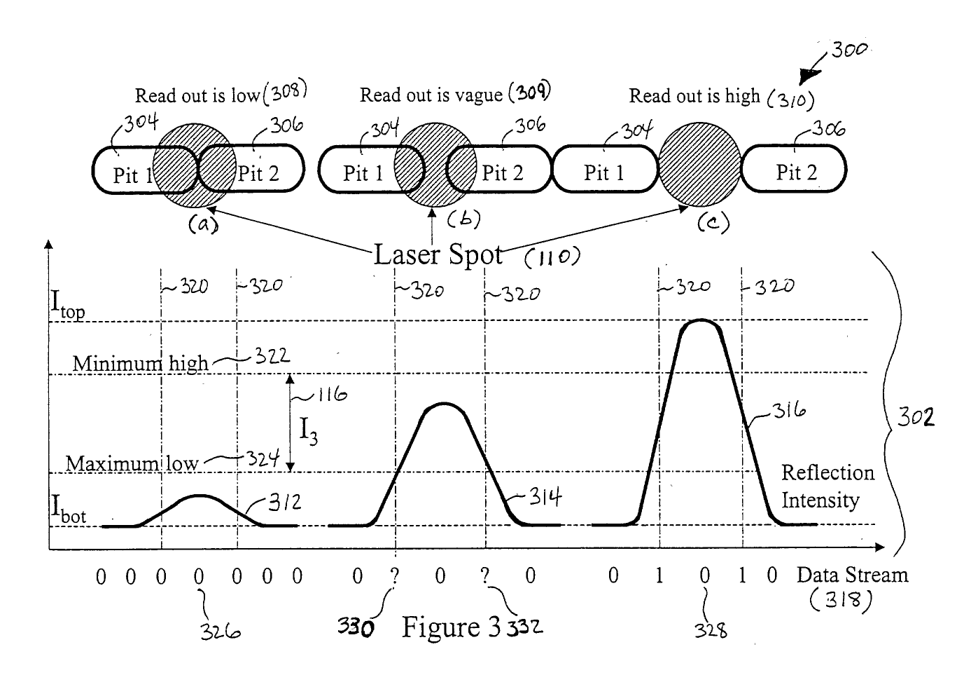

FIG. 3 is an exemplary illustration 300 that depicts one example of one or more vague bits on a track of a storage medium according to the present invention. According to this example, distance modulation between two neighboring pits is used to produce the one or more vague bits. It is assumed that the laser spot 110 is produced by a laser (not shown) of a particular media player as described above with reference to FIG. 1. The laser spot 110 further depicts the locations at which samples along a track of a medium are taken as also described with reference to FIG. 1 above. It is further assumed that a land is either above or below the pits in the exemplary illustration 300 of FIG. 3. FIG. 3 depicts an exemplary intensity reflection reading waveform 302, which comprises three exemplary intensity reflection reading sections 312, 314 and 316 of the waveform 302 that correspond to locations (a), (b) and (c) on the storage medium, respectively. Additionally, in the waveform 302 of FIG. 3 there are depicted a minimum intensity reflection high 322 and a maximum intensity reflection low 324. In the exemplary illustration 300 of FIG. 3, there is further depicted a data stream 318, which represents bits obtained from a plurality of taken samples. It is noted that only the pertinent samples taken at locations (a), (b) and (c) will be described in detail.

As illustrated in FIG. 3 at location (a), neighboring pit 304 and pit 306 are contiguous to one another. The surface area that pit 304 and pit 306 occupy in correspondence to the land, which is either below or above the pits, is approximately 50 percent. When a sample is taken at location (a), the light reflected from the pits 304 and 306 destructively cancels the light reflected from the land. Therefore, the intensity reflection reading obtained by the detector of the particular media player is a minimum intensity reflection reading 308. More specifically, with respect to location (a), the intensity reflection reading sections 312 of the waveform 302 shows that the obtained intensity reflection reading is well below the maximum intensity reflection low 324 and is thus converted to zero 326 in the binary data stream 318.

As illustrated in FIG. 3 at location (c), neighboring pit 304 and pit 306 are not contiguous, as well as being on a periphery of the laser spot 110 (i.e., distance between pits 304 and 306 is approximately the diameter of laser spot 110). When the sample is taken at location (c), the intensity reflection reading obtained by the detector of the particular media player is a maximum intensity reflection reading 310. More specifically with regard to location (c), the intensity reflection reading in section 316 of waveform 302 shows that the light reflection, which is mostly reflected from the land, is well above the minimum intensity reflection high 322. Therefore, the media player converts the intensity reflection reading at location (a) to a zero 328 in the binary stream 318.

As illustrated in FIG. 3 at location (b), the distance between neighboring pit 304 and pit 306 is modulated so that when the sample is taken at location (b), the intensity reflection reading obtained by the detector of the media player is a vague intensity reflection reading 309, i.e., approximately midway between minimum intensity reflection reading 308 of location (a) and the maximum intensity reflection reading 310 and the maximum intensity reflection reading of location (c). The vague intensity reflection reading 309 at location (b) is between the maximum intensity reflection low 324 and a minimum intensity reflection high 322 in the waveform 302. Intensity reflection reading section 314 of waveform 302 shows that the media player translates the vague intensity reflection reading 309 to vague bits 330 and 332 (represented by question marks) at transitions 320.

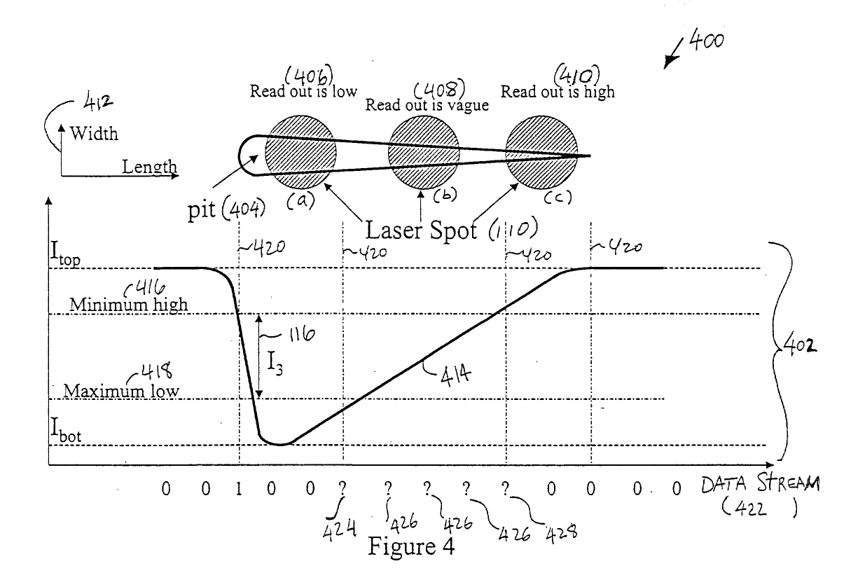

FIG. 4 is an exemplary illustration 400 that depicts another example of one or more vague bits on a track of a storage medium according to the present invention. According to this example, width modulation of a single pit 404 is used to produce the one or more vague bits. The direction of the length and width of the pit 404 is represented by reference 412. As in the previous example of FIG. 3, in FIG. 4 it is assumed that the laser spot 110 depicts the locations at which samples are taken along a track of the storage medium. It is further assumed that a land is either above or below the pit 404 in the exemplary illustration 400 of FIG. 4. FIG. 4 further depicts an exemplary intensity reflection reading waveform 402, which comprises an exemplary intensity reflection reading section 414 that corresponds to locations (a), (b) and (c) on the storage medium. Additionally, in the waveform 402 of FIG. 4 there are depicted a minimum intensity reflection high 416 and a maximum intensity reflection low 418. In FIG. 4 there is further depicted a data stream 422, which represents one or more bits obtained from a plurality of taken samples. It is noted that only the pertinent samples taken at locations (a), (b) and (c) will be described in detail.

As illustrated at location (a) in FIG. 4, the width of pit 404 is approximately half the diameter of the laser spot 110. When a sample is taken at location (a), the light reflected from the pit 404 destructively cancels the light reflected from the land, either above or below the pit 404. Therefore, the intensity reflection reading obtained by the detector of the particular media player is a minimum intensity reflection reading 406, represented by the intensity reflection reading section 414 and the associated bit of zero in the binary data stream 422. As illustrated at location (c) in FIG. 4, the width of pit 404 is approximately zero. When a sample is taken at location (c), the intensity reflection reading obtained by the detector of the particular media player is a maximum intensity reflection reading 410, and is represented by the intensity reflection reading section 414 and the associated bit of zero in the binary data stream 422. This is so because the light reflected at location (c) is mostly reflected from the land. As illustrated at location (b) of FIG. 4, the width of pit 404 is modulated between the width of the pit 404 at location (a) and the width of pit 404 at location (c). Thus, when the sample is taken at location (b), the intensity reflection reading obtained by the detector of the particular media player is a vague intensity reflection reading 408, i.e., approximately midway between the minimum intensity reflection reading at location (a) and the maximum intensity reflection reading at location (c). More particularly, the intensity reflection reading section at location (b) for the waveform 302 is between the maximum intensity reflection low 418 and the minimum intensity reflection high 416. As can be seen in illustration 400 of FIG. 4, the width of pit 404 varies gradually from approximately half the laser spot 110 to approximately zero, which in effect varies the intensity reflection reading to produce the one or more vague bit 424-428.

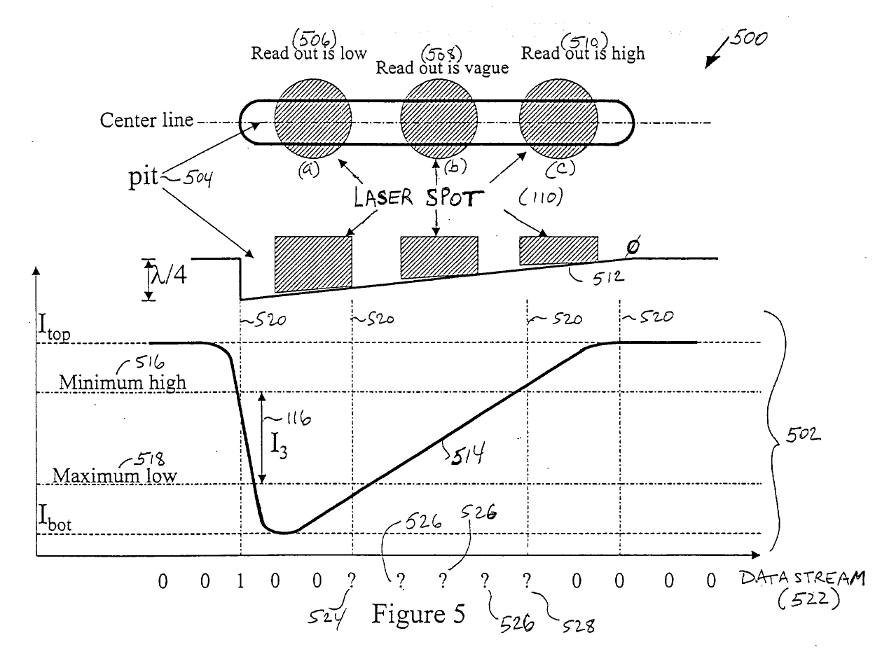

FIG. 5 is an exemplary illustration 500 that depicts yet another example of one or more vague bits on a track of a storage medium according to the present invention. According to this example, depth modulation of a single pit 504 is used to produce the one or more vague bits. As in the previous examples of FIGS. 3 and 4, in FIG. 5 it is assumed that the laser spot 110 depicts the locations at which samples are taken along a track of the storage medium. It is further assumed that a land is either above or below the pit 504 in the exemplary illustration 500 of FIG. 5. FIG. 5 further depicts an exemplary intensity reflection reading waveform 502, which comprises an exemplary intensity reflection reading section 514 that corresponds to locations (a), (b) and (c) on the storage medium. Additionally, in the waveform 502 of FIG. 5 there are depicted a minimum intensity reflection high 516 and a maximum intensity reflection low 518. There is further depicted a data stream 522, which represents one or more bits obtained from a plurality of taken samples. As before, only the pertinent samples taken at locations (a), (b) and (c) will be described in detail. FIG. 5 further depicts a cross-sectional view 512 at a centerline of pit 504, illustrating the modulation of the depth of pit 504.

Further with regard to FIG. 5, as particularly illustrated at location (a), the depth of pit 504 is approximately one-quarter of a wavelength in the digital storage media for a particular media player. When a sample is taken at location (a), the light reflected from the pit 504 destructively cancels the light reflected from the land, either above or below the pit 504. Therefore, the intensity reflection reading obtained by the detector of the particular media player is a minimum intensity reflection reading 506, represented by the intensity reflection reading section 514 and the associated bit of zero in the binary data stream 522. Now, as illustrated at location (c), the depth of pit 504 is approximately zero. When a sample is taken at location (c), the intensity reflection reading obtained by the detector of the particular media player is a maximum intensity reflection reading 510, and is represented by the intensity reflection reading section 514 and the associated bit of zero in the binary data stream 522. This is so because the light reflected from the pit 504 at location (c) does not destructively cancel the reflected light from the land, thereby producing a maximum intensity reflection reading 510. As illustrated at location (b) of FIG. 5, the depth of pit 504 is modulated between the depth of the pit 504 at location (a) and the depth of pit 504 at location (c). Thus, when the sample is taken at location (b), the intensity reflection reading obtained by the detector of the particular media player is a vague intensity reflection reading 508, i.e., approximately midway between the minimum intensity reflection reading at location (a) and the maximum intensity reflection reading at location (c). More particularly, the intensity reflection reading section 514 at location (b) for the waveform 502 is between the maximum intensity reflection low 518 and the minimum intensity reflection high 516. As can be seen in illustration cross-sectional view 512 of FIG. 5, the depth of pit 504 varies gradually from approximately one-quarter of the laser wavelength in the storage media to approximately zero, which in effect varies the intensity reflection reading to produce the one or more vague bit 524-528.

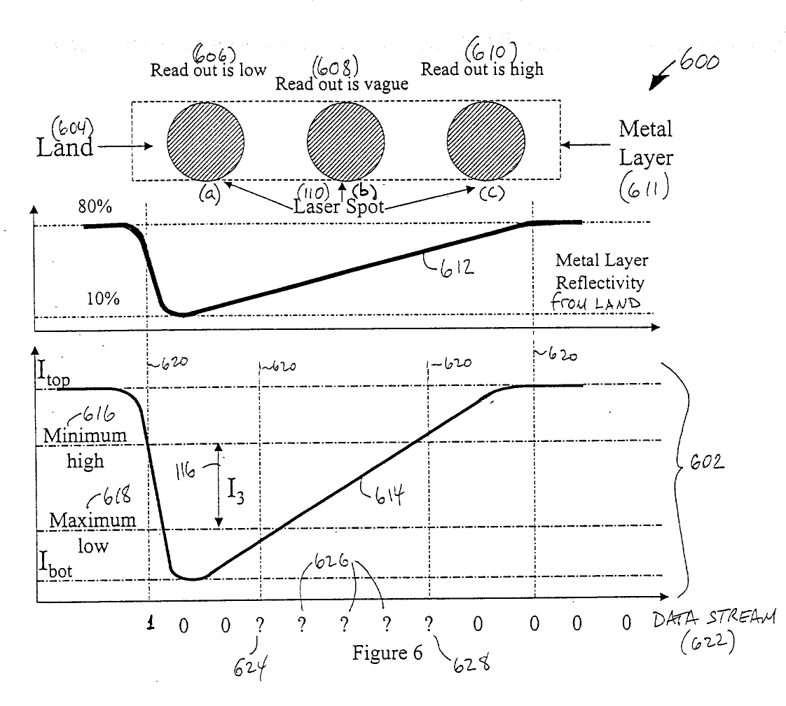

FIG. 6 an exemplary illustration 600 that depicts still another example of one or more vague bits on a track of a storage medium according to the present invention. According to this example, reflectivity modulation of a metal layer 611 over a land 604 is used to produce the one or more vague bits. As in the previous examples of FIGS. 3-5, in FIG. 6 it is assumed that the laser spot 110 depicts the locations at which samples are taken along a track of the storage medium. In this example, it is further assumed the samples are taken only over the land 604. FIG. 6 further depicts an exemplary intensity reflection reading waveform 602, which comprises an exemplary intensity reflection reading section 614 that corresponds to locations (a), (b) and (c) on the storage medium. Additionally, in the waveform 602, there are depicted a minimum intensity reflection high 616 and a maximum intensity reflection low 618. There is further depicted a data stream 622, which represents one or more bits obtained from a plurality of taken samples. As before, only the pertinent samples taken at locations (a), (b) and (c) will be described in detail. FIG. 6 further depicts a waveform 612 that illustrates metal layer reflectivity modulation over a land 604 used to produce the one or more vague bits.

Further with regard to FIG. 6, as particularly illustrated at location (a), the reflectivity of the metal layer 611 is at approximately 80 percent. Typically, reflection from a metal layer 611 is uniform, i.e., the metal layer reflecting approximately 80 percent of light. According to FIG. 6, the reflectivity of the metal layer is modulated between 80 percent and 10 percent, as illustrated by the reflectivity waveform 612. This is preferably achieved by modulating a high-intensity laser scanning a predetermined land region and burning or ablating the metal layer 611 corresponding to that land 604. More particularly, the burning causes a decrease in the metal layer's 611 reflectivity. Modulating the reflection from the metal layer 611 at predetermined locations on the storage medium is utilized to obtain the one or more vague bits. Thus, at location (a), the reflectivity of the metal layer is at a low of 10 percent. Consequently, the intensity reflection reading obtained by the detector of the particular media player is a minimum intensity reflection reading 606, represented by the intensity reflection reading section 614 and the associated bit of zero in the binary data stream 622. Now, as illustrated at location (c), the reflectivity of the metal layer 611 is at a high of 80 percent. When a sample is taken at location (c), the intensity reflection reading obtained by the detector of the particular media player is a maximum intensity reflection reading 610, and is represented by the intensity reflection reading section 614 and the associated bit of zero in the binary data stream 622. However, as illustrated at location (b) in reflectivity waveform 612, the reflectivity of the metal layer 611 is modulated to approximately between the reflectivity at location (a) and the reflectivity at location (c). Thus, when the sample is taken at location (b), the intensity reflection reading obtained by the detector of the particular media player is a vague intensity reflection reading 608, i.e., approximately midway between the minimum intensity reflection reading at location (a) and the maximum intensity reflection reading at location (c). More particularly, the intensity reflection reading section 614 at location (b) for the waveform 602 is between the maximum intensity reflection low 618 and the minimum intensity reflection high 616. As can be seen in illustration 600 of FIG. 6, the reflectivity of the metal layer may be varied from approximately 80 percent to approximately zero percent, which in effect varies the intensity reflection reading from a land 604 to produce the one or more vague bit 624-628.

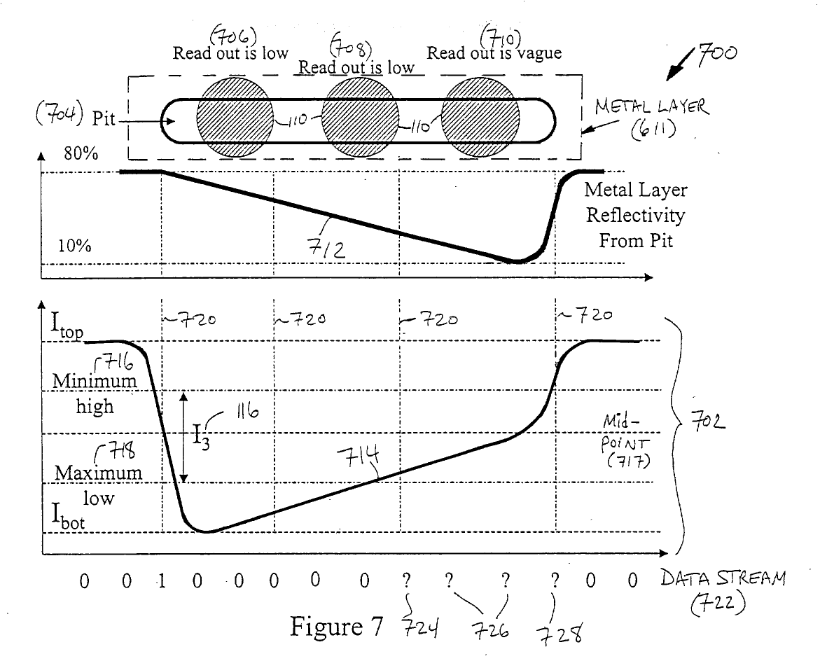

FIG. 7 an exemplary illustration 700 that depicts a further example of one or more vague bits on a track of a storage medium according to the present invention. According to this example, reflectivity modulation of a metal layer 611 over a pit 704 is used to produce the one or more vague bits. As in the previous examples of FIG. 6, in FIG. 7 it is assumed that the laser spot 110 depicts the locations at which samples are taken along a track of the storage medium. In this example, it is further assumed the samples are taken only over the pit 704. FIG. 7 further depicts an exemplary intensity reflection reading waveform 702, which comprises an exemplary intensity reflection reading section 714 that corresponds to locations (a), (b) and (c) on the storage medium. Additionally, in the waveform 702, there are depicted a minimum intensity reflection high 716 and a maximum intensity reflection low 718. There is further depicted a data stream 722, which represents one or more bits obtained from a plurality of taken samples. As before, only the pertinent samples taken at locations (a), (b) and (c) will be described in detail. FIG. 7 further depicts a waveform 712 that illustrates metal layer reflectivity modulation over a pit 704 used to produce the one or more vague bits.

Further with regard to FIG. 7, as particularly illustrated at locations (a), the reflectivity of the metal layer 611 is at approximately 80 percent. The reflection from a metal layer 611 is typically uniform, i.e., the metal layer reflecting approximately 80 percent of light. According to FIG. 7, the reflectivity of the metal layer is modulated between 80 percent and 10 percent, as illustrated by the reflectivity waveform 712. This is preferably achieved by modulating the high-intensity laser scanning a predetermined land region and burning or ablating the metal layer 611 corresponding to that pit 704. More particularly, the burning causes a decrease in the metal layer's 611 reflectivity. Modulating the reflection from the metal layer 611 at predetermined locations on the storage medium is utilized to obtain the one or more vague bits. Thus, at location (a), the reflectivity of the metal layer is at a high of 80 percent. Consequently, the intensity reflection reading obtained by the detector of the particular media player is a minimum intensity reflection reading 706, represented by the intensity reflection reading section 714 and the associated bit of zero in the binary data stream 722. It is noted that the metal layer reflectivity over a pit is inversely proportional to the intensity reflection reading obtained by the media player. More specifically, when an intensity reflection from a pit represents a minimum intensity (i.e., approximately 0 percent), there is no destructive interfere with the reflection from a land (either above or below the pit), so that the intensity reflection reading from the location over the pit is at about a midpoint 702 between the maximum intensity reflection reading low 718 and the minimum intensity reflection high 716 on the waveform 702. However, when the reflection intensity from the pit is a maximum intensity (i.e., approximately 80 percent), the reflected light from the pit will destructively cancel the reflected light from the land. Consequently, in this case the reflection intensity is a minimum intensity reflection.

Still further with regard to FIG. 7, at location (b), the reflectivity of the metal layer 611 in waveform 712 is gradually modulated to below the typical 80 percent. Consequently, the intensity reflection reading obtained by the detector of the particular media player inversely proportionally rises, but still remains at a minimum intensity reflection reading 708, as represented by the intensity reflection reading section 714 and the associated bit of zero in the binary data stream 722. However, at location (c), the reflectivity of the metal layer 611 is modulated to a low of ten percent. When a sample is taken at location (c), the intensity reflection reading obtained by the detector of the particular media player is a vague intensity reflection reading 710, and is represented by the intensity reflection reading section 714 and the associated vague bits 724-728 in the binary data stream 722. The vague intensity reflection reading 710 is approximately midway between the minimum intensity reflection reading at location (a) and the maximum intensity reflection reading at location (b). More particularly, the intensity reflection reading section 714 at location (c) for the waveform 702 is between the maximum intensity reflection low 718 and the minimum intensity reflection high 716 (i.e., at approximately midpoint 717). As can be seen in illustration 700 of FIG. 7, the reflectivity of the metal layer 611 may be varied from approximately 80 percent to approximately 10 percent, which in effect inversely proportionally varies the intensity reflection reading from the pit 704 to produce the one or more vague bit 724-728.

With regard to FIGS. 3-7, as described above, the laser power from different media players may be different by approximately 10 percent. As such, the minimum intensity reflection high and the maximum intensity reflection low for each of the players may be different. To account for the difference in laser power and to be certain that any media player may detect one or more vague bits, a plurality of vague bits is provided as follows. In the case of distance modulation between pits 304 and 306 in FIG. 3, a plurality of pit pairs with each successive pit pair having a greater pit-distance modulation is provided. For example, the pairs of pits 304 and 306 may have a distance between associated pits vary from approximately zero to approximately the diameter of the laser spot size 110. In the case of width modulation of pit 404 in FIG. 4, the width of pit 404 varies from approximately half the laser diameter to approximately zero. In the case of depth modulation of pit 504 in FIG. 5, the depth varies from approximately one-quarter of the laser wavelength in the storage media to approximately zero. In the case of modulation of the metal layer reflectivity in FIGS. 6 and 7, the reflectivity of metal layer 611 varies from approximately 10 percent to approximately 80 percent and vice versa. Consequently, no matter what the minimum intensity reflection high and the maximum intensity reflection low are for a particular media player, there will always be locations at which the intensity reflection reading will be vague (i.e., a vague bit). Additionally, it is preferable to dispose additional vague bits of the same character (i.e., same distance modulated, width modulated, depth modulated or metal layer reflectivity modulated vague bits) along one or more tracks of a storage medium for redundancy. Furthermore, different combinations of the foregoing vague bits may be disposed along the one or more tracks of a storage medium for redundancy.

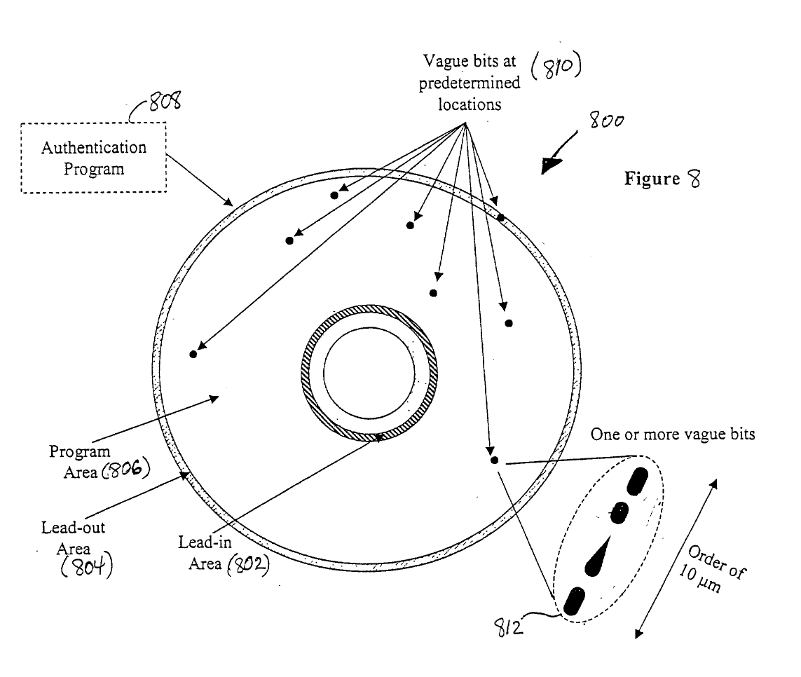

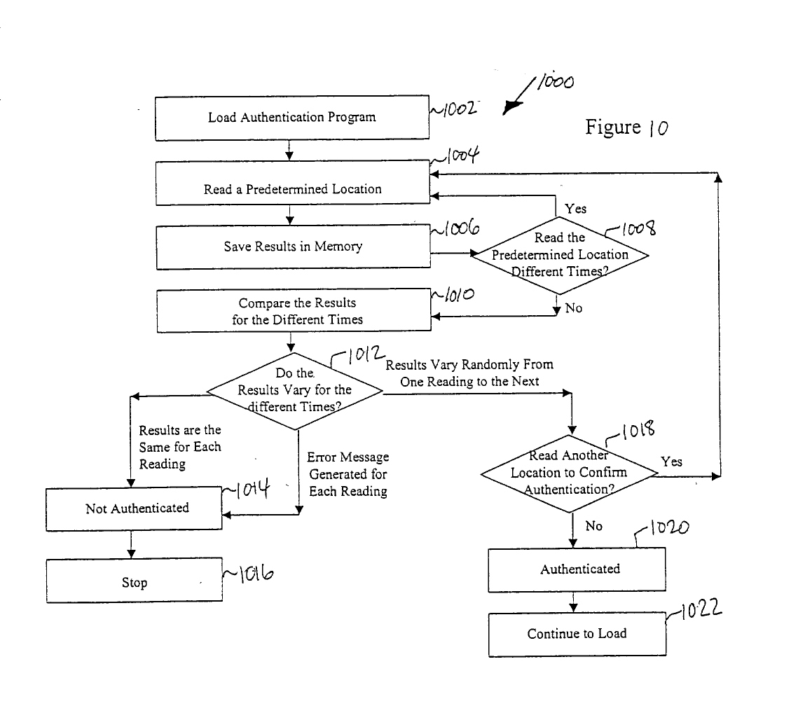

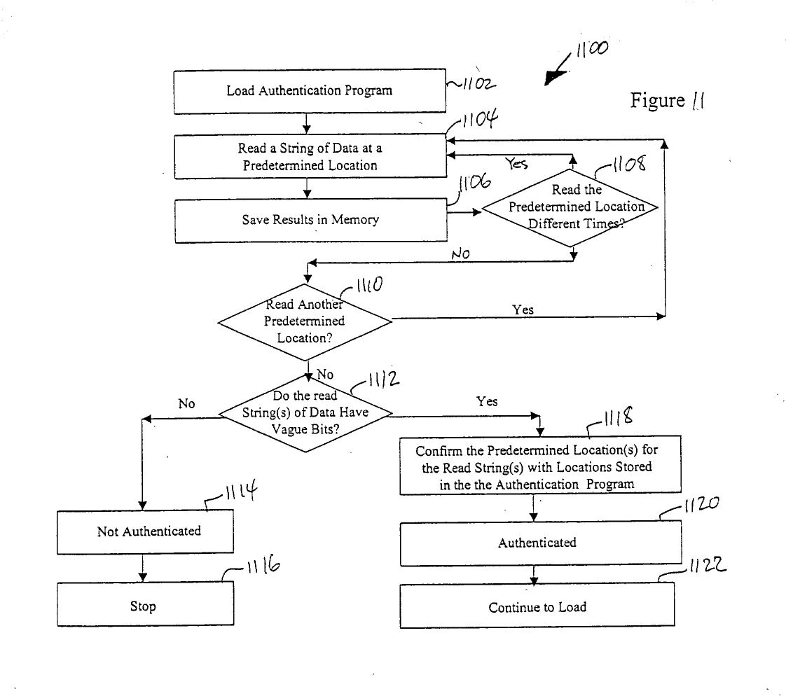

FIG. 8 is an exemplary storage medium 800 (e.g., an optical storage medium) according to the present invention. The storage medium 800 comprises a lead-in area 802, which includes digital silence (or zero data) in a main channel plus a table of contents in a sub-code Q-channel. The lead-in area enables the laser of the media player to follow the lands and pits and synchronize to the digital content in a program area 806. The digital content in the program area 806 includes data, whether audio, video, or computer data, that is generally interleaved into a plurality of tracks. The lead-out area 804 includes digital silence (or zero data) to define the end of the program area 806. According to FIG. 8, the storage medium 800 further comprises an authentication program 808 that may be disposed at the lead-in area 802 or program area 806 for authenticating the storage medium 800, thereby providing copy protection if the storage medium is not authentic as will be described below in FIGS. 10 and 11.

With specific reference to the authentication program 808 in FIG. 8, when the authentication program 808 is stored in the lead-in area 802, the media player automatically reads the lead-in area 802, and thus automatically loads and executes the authentication program 808. If the authentication program 808 is disposed at a location in the program area 806, when the media player read this location, the authentication program is automatically loaded and executed by the media player. Additionally, the authentication program 808 may be bundled together with an installation program for installing the digital content stored on the digital storage medium 800 onto a personal computer (i.e., “PC”), such as, a setup.exe file for a Windows™ environment. Thus, at installation time, the authentication program 808 is executed.

Further with reference to FIG. 8, the storage medium 800 further comprises (if authentic) one or more vague bits disposed at predetermined locations 810 of one or more predetermined tracks of the storage medium 800 according to the present invention. As depicted at a magnified section 812, one of such predetermined locations 810, which comprises one or more vague bits, is on the order of 10 μm. In exemplary fashion, the magnified section 812 illustrates one or more vague bits obtained by the various techniques in accordance with the present invention (i.e., distance modulation, width modulation, depth modulation, and metal layer reflectivity modulation). The digital content stored on the storage medium 800 is protected in such a way that the media player cannot read the digital content (or a portion thereof) without executing the authentication program 808. If the authentication program 808 cannot find the one or more vague bits at predetermined locations 810 on the storage medium 800, the media player is directed to stop playing the digital storage medium 800, thereby denying a user access to the digital content stored on the storage medium 800. Additionally, if the authentication program 808 is bundled together with an installation program, the installation program will be terminated if the authentication program 808 cannot find the one or more vague bits at predetermined locations 810 on the storage medium 800, thereby denying a user access the digital content stored on the storage medium 800.

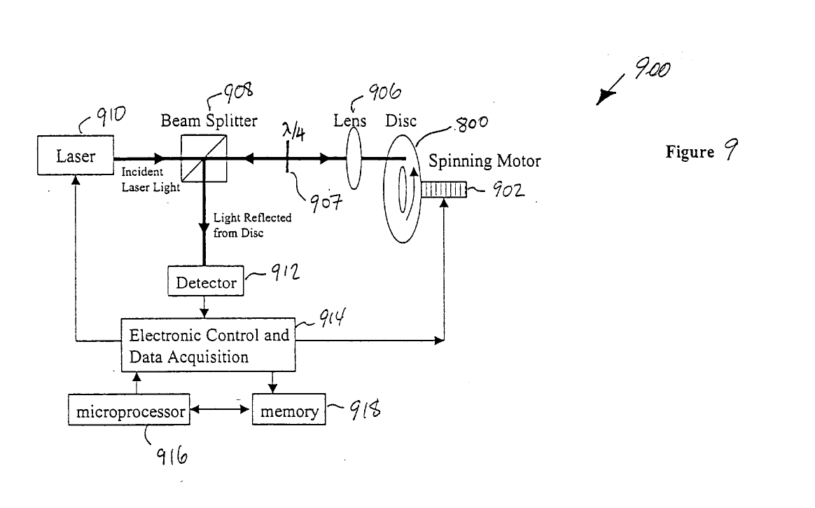

FIG. 9 is an exemplary media player 900 (e.g., optical media player) that may be employed to execute the authentication program 808 to authenticate a storage medium 800 according to the present invention (i.e., determining whether one or more vague bits exist at predetermined locations on the storage medium 800). The media player 900 is preferably a conventional optical media player and additional hardware may not required. However, the present invention is not limited to the media player 900, as other media players with like components may easily be implemented according to the present invention. The media player 900 comprises a motor 902 that spins the storage medium 800. The electronic control and data acquisition circuit 914 controls the spinning speed of the motor 902 and the position of the laser 910 upon the storage medium 800. The incident light produced by laser 910 is transmitted through a beam splitter 908 to a quarter-waveplate 907, which rotates the polarization of the incident laser light 45 degrees. The objective lens 906 focuses the incident laser light on the storage medium 800. The storage medium 800 reflects the incident laser light and the objective lens 906 collects the reflected light to the quarter-waveplate 907, which further rotates the polarization of the reflected light 45 degrees. Because the polarization of the reflected light has been rotated 90 degrees, the beam splitter reflects the reflected light to the detector 912. The detector 912 reads the intensity of the light reflected from the storage medium and transfers the signal to electronic circuit 914. The electronic control and data acquisition circuit 914 decodes the signal and transfers it to the memory 918. The microprocessor 916 controls the electronic control and data acquisition circuit 914.

FIG. 10 is an exemplary flowchart 1000 that depicts one example for authenticating a storage medium in accordance with the present invention. It is assumed the storage medium has been inserted into a media player, such as media player 900, which is capable of reading the storage medium. It is further assumed that a user tries to read the storage medium using the media player. Now with reference to flowchart 1000, at step 1002, the media player loads the authentication program 808 into memory 918 and the microprocessor 916 executes the authentication program 808, which comprises steps 1004-1022 described below. At step 1004, the player reads a predetermined location 810 on the storage medium 800, obtaining a bit in the binary data stream. At step 1006, the read results for the predetermined location are stored in memory 918. At step 1008, it is determined whether the predetermined location is to be read a different number of times. If the predetermined location is to be read a number of times, the predetermined location is again read at step 1004. Otherwise, if the predetermined location is not to be read again, the flowchart 1000 continues at step 1010. It is preferable that the predetermined location is read at least twice. At step 1010, the results from the different readings of the predetermined location 810 are compared against one another.

Further with reference to FIG. 10, at step 1012, it is determined whether the results for the readings at different times vary from one to the other. If the results are substantially the same for each reading or an error message is generated for each reading, at step 1014, the authentication program 808 does not authenticate the storage medium 800. Thus, at step 1016, the authentication program 808 directs the electronic control and data acquisition circuit 914 to stop spinning the storage medium 800 (i.e., stopping the storage medium from being read by the media player). However, if at step 1012, it is determined that the results for each reading vary randomly from one reading to the next, then the flowchart continues at step 1018. It is assumed here, that the result variance for different readings indicates a possible vague bit at the predetermined location, i.e., representing possible authentication. At step 1018, it is further determined whether it is necessary to confirm the possible authentication of the storage medium 800. The authentication program 808 presets the number of iterations for confirming whether the storage medium 800 is authentic. If at step 1018, it is determined that the results need to be confirmed, the flowchart 1000 iterates to step 1004 to read another predetermined location on storage medium 800. However, if it is determined that no further confirmation is necessary, at step 1020, the storage medium is authenticated. At step 1022, the player continues to load the data in the program area 806 of the storage medium 800, in a conventional manner.

FIG. 11 is an exemplary flowchart 1100 that depicts another example for authenticating a storage medium in accordance with the present invention. It is likewise assumed that the storage medium has been inserted into a media player, such as media player 900, which is capable of reading the storage medium. It is further assumed that a user tries to read the storage medium using the media player. Now with reference to flowchart 1100, at step 1102, the media player loads the authentication program 808 into memory 918 and the microprocessor 916 executes the authentication program 808, which comprises steps 1104-1122 described below. At step 1104, the media player reads a string of data at predetermined location 810 on the storage medium 800. It is noted, that the string of data comprises one or more vague bits, as well as non-vague bits. At step 1106, the results (i.e., string of data) are saved to memory 918. At step 1108, it is determined whether to read the predetermined location a number of times. If the location is to be read a number of times, the flowchart 1100 continues at step 1104. Otherwise, if it is determined not to read the predetermined location a different number of times, the flowchart 1100 continues at step 1110. Preferably, the predetermined location is read at least twice. Thereafter, at step 1110 it is determined whether to read another predetermined location 810 on the storage medium 800. Steps 1104 and 1108 are repeated for all subsequent predetermined locations to be read. However, if no other predetermined location is to be read, at step 1112, it is determined whether the strings of data for every predetermined location read have vague bits. That is, the same bit in all read strings for the each predetermined location are compared to determine whether there are vague bits present (i.e., whether the same bit varies randomly from one string to another for the predetermined location). If it is determined at step 1112 that no vague bits exist, at step 1114 the storage medium is not authenticated. Then at step 1116, the authentication program 808 directs the electronic control and data acquisition circuit 914 to stop spinning the storage medium 800. However, if at step 1112 there are vague bits in the strings, then at step 1118, positions for the vague bits in the strings are confirmed with the authentication program 808. At step 1120, the storage medium is authenticated. At step 1122, the media player continues to load the data in the program area 806 of the storage medium 800, in a conventional manner.

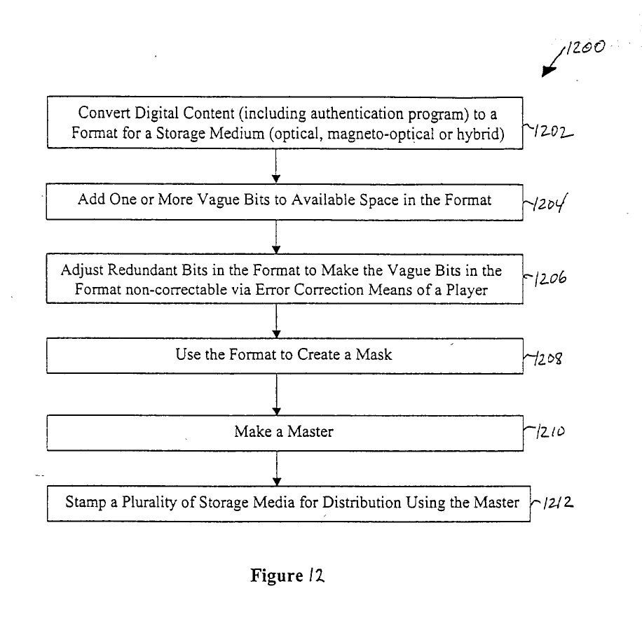

FIG. 12 is an exemplary flowchart 1200 of a first example for creating a storage medium comprising one or more vague bits according to the present invention. At step 1202, digital content to be recorded on the storage medium, including the authentication program, are converted to a format for the type of storage medium, such as optical, magneto-optical or hybrid medium. At step 1204, one or more vague bits are added to the predetermined available space in the format. The one or more vague bits can be added by any one of the following modulating techniques: modulating a distance between two pits, modulating a width of a pit, and modulating a depth of a pit. Single-layer lithography can easily be implemented to achieve distance and width modulation, while multi-layer lithography can easily be implemented to achieve the depth modulation. At step 1206, the redundant bits in the format are adjusted, as described below, to make the added vague bits in the format non-correctable via error correction means of a player. The format is utilized to create a mask at step 1208. At step 1210, a master is created utilizing the mask. Finally, at step 1212, a plurality of storage media is stamped utilizing the master. Among other things, each of the plurality of storage media comprises a combination of digital content, authentication program and vague bits.

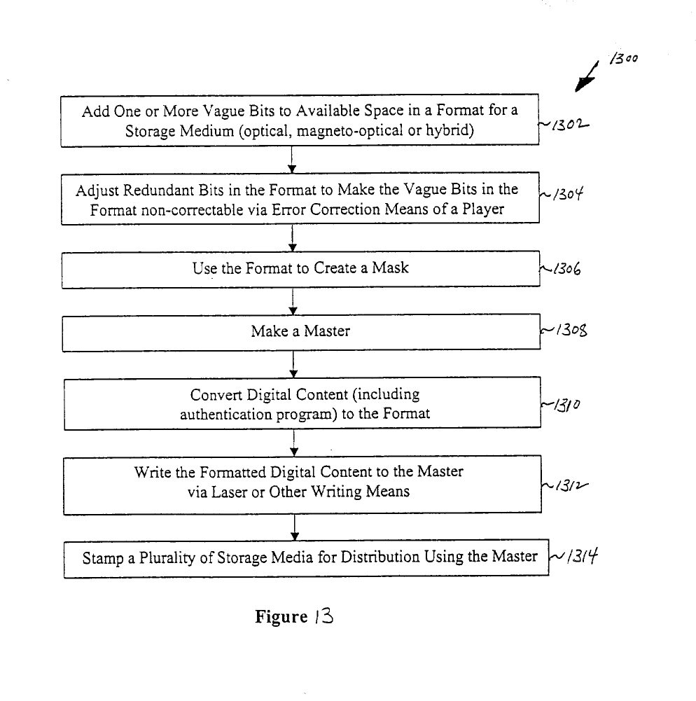

FIG. 13 is an exemplary flowchart 1300 of a second example for creating a storage medium comprising one or more vague bits according to the present invention. At step 1302, one or more vague bits are added to the available space in a format for the type of storage medium, such as optical, magneto-optical or hybrid medium. As described above with reference to FIG. 12, the one or more vague bits can likewise be added by any one of the following modulating techniques: modulating a distance between two pits, modulating a width of a pit, and modulating a depth of a pit. Again, single-layer lithography can easily be implemented to achieve distance and width modulation, while multi-layer lithography can easily be implemented to achieve the depth modulation. At step 1304, the redundant bits in the format are adjusted to make the added vague bits in the format non-correctable via error correction means of a player. At step 1306, the format is utilized to create a mask. A master is created utilizing the mask at step 1308. At step 1310, digital content to be recorded on the storage medium, including the authentication program, are converted to the format for the type of storage medium. At step 1312, the formatted digital content is written to the master via laser or other comparable writing means. Finally, at step 1314, a plurality of storage media is stamped for distribution utilizing the master.

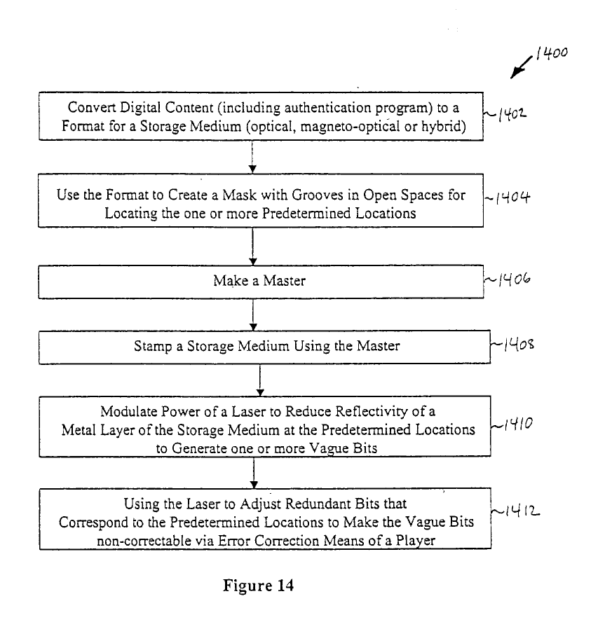

FIG. 14 is an exemplary flowchart 1400 of a third example for creating a storage medium comprising one or more vague bits according to the present invention. At step 1402, digital content to be recorded on the storage medium, including the authentication program, are converted to a format for the type of storage medium, such as optical, magneto-optical or hybrid medium. At step 1404, the format is utilized to create a mask with grooves in open spaces for locating one or more predetermined locations. A master is created utilizing the mask at step 1406. At step 1408, a storage medium is stamped utilizing the master. It is noted that a plurality of storage media may be stamped utilizing a master. At step 1410, the power of a laser is modulated to reduce reflectivity of a metal layer of the storage medium at the predetermined locations to generate the one or more vague bits. More specifically, the power of the laser is modulated to partially ablate the predetermined locations of the reflective metal layer, thereby creating locations with reduced reflectivity (i.e., the one or more vague bits). Finally, at step 1412, the laser is used to adjust redundant bits that correspond to the predetermined locations of the added vague bits to make the vague bits non-correctable via error correction means of a player.

With regard to FIGS. 12-14, redundant bits (in the form of error correction symbols) are adjusted during or after the formation of the storage media in FIGS. 12-14 to disable error correction means of the media player from correcting the one or more vague bits disposed along one or more tracks of the storage media during playback of the storage media. Conventionally, the redundant bits are mathematically determined to correspond to the other digital content written on the storage media in such a way that the media player can use them as it reads the storage media, not only to determine if errors have occurred, but under certain conditions to correct the errors. A fixed number of redundant bit are compacted to form a data structure known as an error correction codeword (i.e., “ECC”). During reading of the storage media, if a media player encounters a channel sequence with two transitions, which are less than “3T” (consecutive two bits of value 1 in the binary data stream) or more than “11T” (two bits of value 1 separated by more than 10 bits of value zero) apart, the media player flags the bit as invalid and marks the invalid bit for “erasure”. In decoding and re-ordering processes, the media player using the ECC will automatically correct an invalid bit marked for “erasure”. The ECC can only be used to correct a limited number of errors. That is, the media player will be able to detect errors in excess of these limits with finite probability, but the media player will not be able to correct them. Additionally, the probability of detecting errors decreases as the number of errors in the ECC increases.

Further with regard to FIGS. 12-14, one way to adjust the redundant bits is to override or disable the ECC's auto-correction ability. This is preferably done by adjusting the redundant bits in a pattern in the ECC, which creates errors in the ECC in excess of the associated limits. Furthermore, if the pattern is created in specific, selected ECCs, which correspond to the one or more vague bits disposed on the storage media, the media player will not be able correct the one or more vague bits associated with the particular ECC, but will pass one or more vague bits uncorrected. Therefore, the adjustment of the redundant bits makes the one or more vague bits non-correctable by the media player's error correction means.

While the invention has been particularly shown and described with regard to preferred embodiments thereof, it will be understood by those skilled in the art that the foregoing and other changes in form and details may be made therein without departing from the spirit and scope of the invention.

1. A storage medium capable of being read by a player, the storage medium comprising:
digital content disposed along one or more tracks of the storage medium;
one or more vague bits disposed at one or more predetermined locations along the one or more tracks of the storage medium; and
an authentication program disposed along the one or more tracks of the storage medium for authenticating the storage medium by determining whether the one or more vague bits exist at the one or more predetermined locations.

2. The storage medium according to claim 1, further comprising one or more redundant bits disposed along the one more tracks that are adjusted so as to make the one or more vague bits non-correctable via a correction means associated with the player during reading of the storage medium.

3. The storage medium according to claim 1, wherein the digital content is disposed in a program area of the storage medium.

4. The storage medium according to claim 1, wherein the one or more vague bits are disposed in a program area of the storage medium.

5. The storage medium according to claim 1, wherein the authentication program is disposed in a predetermined location of a program area of the storage medium.

6. The storage medium according to claim 1, wherein the authentication program is disposed in a predetermined location of a lead-in area of the storage medium.

7. The storage medium according to claim 1, wherein at least one of the one or more vague bits is produced by modulation of distance between two neighboring pits along a predetermined location during reading of the storage medium by the player.

8. The storage medium according to claim 1, wherein at least two of the one or more vague bits are produced by modulation of distance between two neighboring pits along one or more predetermined locations during reading of the storage medium by the player, and the modulation of distance increases from the first vague bit to the second vague bit.

9. The storage medium according to claim 1, wherein at least one of the one or more vague bits is produced by modulation of width of a single pit along a predetermined location during reading of the storage medium by the player.

10. The storage medium according to claim 9, wherein the width gradually decreases from one end of the pit to another end of the pit.

11. The storage medium according to claim 1, wherein at least one of the one or more vague bits is produced by modulation of depth of a single pit along a predetermined location during reading of the storage medium by the player.

12. The storage medium according to claim 11, wherein the depth gradually decreases from one end of the pit to another end of the pit.

13. The storage medium according to claim 1, the storage medium further comprising a metal layer, wherein at least one of the one or more vague bits is produced by modulation of reflectivity of the metal layer along a predetermined location during reading of the storage medium by the player.

14. The storage medium according to claim 13, wherein the reflectivity of the metal layer is gradually increased over a land at the predetermined location of the storage medium to obtain the at least one of the one or more vague bits.

15. The storage medium according to claim 13, wherein the reflectivity of the metal layer is gradually decreased over a pit at the predetermined location of the storage medium to obtain the at least one of the one or more vague bits.

16. A storage medium storing digital content capable of being read by a player, the storage medium comprising:
an authentication program disposed along the one or more tracks of the storage medium for authenticating the storage medium by determining whether there exist one or more vague bits disposed at one or more predetermined locations along the one or more tracks of the storage medium.

17. A storage medium storing digital content along one or more tracks capable of being read by a player, the storage medium comprising:
one or more vague bits disposed along one or more predetermined locations along the one or more tracks of the storage medium, at least one of the one or more vague bits is produced by a modulating technique selected from a group consisting of:
i) modulating distance between two pits;
ii) modulating width of a pit;
iii) modulating depth of a pit; and
iv) modulating reflectivity of a metal layer.

18. A method for authenticating a storage medium storing digital content capable of being read by a player, the method comprising:
reading a predetermined location on the storage medium a plurality of times;
comparing results from the plurality of readings of the predetermined location to determine whether the results are substantially the same for each reading; and
directing the player to stop reading the digital content stored on the storage medium if the results are substantially the same.

19. The method for authenticating according to claim 18, the method further comprising a step of saving the results for the plurality of readings in a memory associated with the player.

20. The method for authenticating according to claim 18, the method further comprising the steps of:
authenticating the storage medium if the results for the plurality of readings of the predetermined location vary randomly from reading to reading; and
continuing to read the digital content stored on the storage medium.

21. The method for authenticating according to claim 18, the method further comprising the steps of:
not authenticating the storage medium if the results for the plurality of readings of the predetermined location represent errors in reading the storage medium at the predetermined location.

22. The method for authenticating according to claim 20, the method further comprising a step of confirming the authentication of the storage medium, the confirming comprising the steps of:
reading another predetermined location on the storage medium a plurality of times;
comparing results from the plurality of readings of the predetermined location to determine whether the results are substantially the same for each reading; and
directing the player to stop reading the digital content stored on the storage medium if the results are substantially the same.

23. The method for authenticating according to claim 22, the method further comprising the steps of:
authenticating the storage medium if the results for the plurality of readings of the predetermined location for the confirming step vary randomly from reading to reading; and
continuing to read the digital content stored on the storage medium.

24. The method for authenticating according to claim 20, wherein when the results vary randomly at the predetermined location there is a vague bit present at the predetermined location and when the results are substantially the same at the predetermined location there is no vague bit present at the predetermined location.

25. A method for authenticating a storage medium storing digital content capable of being read by a player, the method comprising:
reading a string of bits at a predetermined location on the storage medium a plurality of times;
comparing strings from the plurality of readings of the predetermined location to determine whether the bits in the string are substantially the same for each reading; and
directing the player to stop reading the digital content stored on the storage medium if the bits in the strings are substantially the same.

26. The method for authenticating according to claim 25, the method further comprising a step of saving the strings for the plurality of readings in a memory associated with the player.

27. The method for authenticating according to claim 25, the method further comprising a step of reading one or more additional predetermined locations.

28. The method for authenticating according to claim 25, the method further comprising a step of determining whether the string has at least one vague bit.

29. The method for authenticating according to claim 28, the determining step further comprising determining when a bit at the same position in the string read from the same predetermined location a plurality of times varies randomly from reading to reading.

30. The method for authenticating according to claim 29, the method further comprising the steps of:
confirming whether a predetermined location having at least one vague bit matches a preset location in an authentication program; and
authenticating the storage medium if confirmed; and
continuing to read the digital content stored on the storage medium.

31. A method for producing a storage medium having authentication and capable of being read by a player, the method comprising:
adding one or more vague bits to a format for the storage medium;
adjusting redundant bits in the format so as to make the one or more vague bits non-correctable via error correction means associated with the player during reading of the storage medium;
creating a mask utilizing the format;
making a master utilizing the mask; and
stamping the storage medium from the master.

32. The method for producing according to claim 31, the method further comprising a step of converting digital content to the format, the digital content including an authentication program for authenticating the storage medium, preceding the adding step.

33. The method for producing according to claim 31, the method further comprising the steps of:
converting digital content to the format, the digital content including an authentication program for authenticating the storage medium; and
writing the formatted digital content to the master utilizing a laser means.

34. A method for producing a storage medium having authentication and capable of being read by a player, the method comprising:
creating a mask utilizing a format for the storage medium, the mask comprising grooves for locating one or more predetermined locations;
making a master utilizing the mask;
stamping the storage medium from the master, the storage medium comprising a metal layer;
adding the one or more vague bits to the storage medium at the one or more predetermined locations by modulating reflectivity of the metal layer at the one or more predetermined locations; and
adjusting redundant bits corresponding to the one or more predetermined locations to make the one or more vague bits non-correctable via error correction means associated with the player during reading of the storage medium.

35. The method for producing a storage medium according to claim 34, the method further comprising a step of converting digital content to the format, the digital content including an authentication program for authenticating the storage medium, preceding the creating step.

36. A program storage device, tangibly embodying a program of instructions executable by a machine to perform a method for authenticating the program storage device storing digital content capable of being read by the machine, the method comprising:
reading a predetermined location on the program storage device a plurality of times;
comparing results from the plurality of readings of the predetermined location to determine whether the results are substantially the same for each reading; and
directing the machine to stop reading the digital content stored on the program storage device if the results are substantially the same.

37. The program storage device according to claim 36, the method further comprising a step of saving the results for the plurality of readings in a memory associated with the machine.

38. The program storage device according to claim 36, the method further comprising the steps of:
authenticating the program storage device if the results for the plurality of readings of the predetermined location vary randomly from reading to reading; and
continuing to read the digital content stored on the program storage device.

39. The program storage device according to claim 36, the method further comprising the steps of:
not authenticating the program storage device if the results for the plurality of readings of the predetermined location represent errors in reading the program storage device at the predetermined location.

40. The program storage device according to claim 38, the method further comprising a step of confirming the authentication of the program storage device, the confirming comprising the steps of:
reading another predetermined location on the program storage device a plurality of times;
comparing results from the plurality of readings of the predetermined location to determine whether the results are substantially the same for each reading; and
directing the machine to stop reading the digital content stored on the program storage device if the results are substantially the same.

41. The program storage device according to claim 40, the method further comprising the steps of:
authenticating the program storage device if the results for the plurality of readings of the predetermined location for the confirming step vary randomly from reading to reading; and
continuing to read the digital content stored on the program storage device.

42. The program storage device according to claim 38, wherein when the results vary randomly at the predetermined location there is a vague bit present at the predetermined location and when the results are substantially the same at the predetermined location there is no vague bit present at the predetermined location.

43. A program storage device, tangibly embodying a program of instructions executable by a machine to perform a method for authenticating the program storage device storing digital content capable of being read by the machine, the method comprising:
reading a string of bits at a predetermined location on the program storage device a plurality of times;
comparing strings from the plurality of readings of the predetermined location to determine whether the bits in the string are substantially the same for each reading; and
directing the machine to stop reading the digital content stored on the program storage device if the bits in the strings are substantially the same.

44. The program storage device according to claim 43, the method further comprising a step of saving the strings for the plurality of readings in a memory associated with the machine.

45. The program storage device according to claim 43, the method further comprising a step of reading one or more additional predetermined locations.

46. The program storage device according to claim 43, the method further comprising a step of determining whether the string has at least one vague bit.

47. The program storage device according to claim 46, the determining step further comprises determining when a bit at the same position in the string read from the same predetermined location a plurality of times varies randomly from reading to reading.

48. The program storage device according to claim 47, the method further comprising the steps of:
confirming whether a predetermined location having at least one vague bit matches a preset location in an authentication program; and
authenticating the program storage device if confirmed; and
continuing to read the digital content stored on the program storage device.
